(19) United States
(12) Patent Application Publication
(10) Pub. No.: US 2007/0103470 A1
(43) Pub. Date: May 10, 2007

(54) Apparatus and method for configuring animated graphic image and effect handler used in the apparatus and method

(75) Inventors: Se-jun Han, Daejon (KR); Ji-taek Lim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD

(21) Appl. No.: 11/515,839

(22) Filed: Sep. 6, 2006

(30) Foreign Application Priority Data
Nov. 5, 2005 (KR) 10-2005-0105733

(51) Int. Cl. G06T 15/70; G06T 13/00

(52) U.S. Cl. 345/473

(57) ABSTRACT

An animated graphic image configuration apparatus and method usingan animated graphic image format including an image header, a component header, an effect header and a component image, and an effect handler used in the apparatus and method are provided. The animated graphic image configuration apparatus is used to generate an animated graphic image using an animated graphic image format including an image header having information on the number of components used for image configuration, component headers having information on the components used for image configuration, effect headers having information on effects applied to each component, and component image corresponding to each component. The effect handler analyzes the animated graphic images format, configures an image frame using header information obtained by the analysis and a decoded component image, and repetitively performs the operation of configuring an image frame and an operation enabling the image generated by the configuration of the image frame to be displayed.

### CROSS-REFERENCE TO RELATED PATENT APPLICATION

This application claims priority from Korean Patent Application No. 10-2005-0105733, filed on Nov. 5, 2005, in the Korean Intellectual Property Office, the disclosure of which is incorporated herein in its entirety by reference.

### BACKGROUND OF THE INVENTION

1. Field of the invention

The present invention relates to an apparatus and a method for configuring an animated graphic image and an effect handler used in the apparatus and the method, and more particularly, to an apparatus and a method using an animated graphic image format including an image header, a component header, an effect header, and a component image and an effect handler used in the apparatus and the method.

2. Description of Related Art

Various methods are used for configuring animated images using a plurality of still images, and an animated graphics interchange format (GIF) method has been widely used. This method is disclosed in PCT International Publication No. WO 2001/95255.

An animated GIF is a vividly animated graphic image on a web page. Examples of animated GIFs include a rotating icon which keeps spinning, a banner in which a hand is waving, and a letter increasing in size with passing time.

The animated GIF is a file in GIF89a format which includes several images in a predetermined order. The animated GIF is capable of infinitely looping or stopping after presenting one or several sequences.

FIG. 1 is a schematic diagram illustrating a structure of a conventional animated GIF file. Referring to FIG. 1, the animated GIF file is created by repeatedly adding a structure including a header, a control part, and image data. In other words, a plurality of images are added sequentially to a header in the animated GIF file. Here, the header defines size, palette, and background color of an animated GIF. The header includes loop information which defines the number of times the file will be repeated.

The control part defines a delay between images, and the delay time is set in units of milli-seconds. In addition, the control part defines a color transparency of a corresponding image.

The image data is comprised of values used to form an image of an animated GIF file. Each set of image data is displayed in a sequence to form a vividly animated image.

A plurality of control parts and image data may be followed by a comment file. The comment file includes information such as the creator's name and comments, and is displayed together with an animated GIF file.

The animated GIF has advantages which may include ease of creation and superior compatibility. However, since an animated GIF must have all the images corresponding to each frame even when an animated image is composed of several components, for example, when showing a specific change in pattern or producing a transition effect using an image in a different frame, a lot of system resources are required.

In addition, since every frame which has to follow the GIF format in an animated GIF is incapable of displaying more than 256 colors, color effects may be limited.

### SUMMARY OF THE INVENTION

The present invention provides an apparatus and method for animated graphic image configuration capable of producing sufficient color effects using less resources, and an effect handler used in the apparatus and method, especially useful when the apparatus or the method is used in a system with limited resources such as an embedded system.

Exemplary embodiments of the present invention overcome the above disadvantages and other disadvantages not described above. Also, the present invention is not required to overcome the disadvantages described above, and an exemplary embodiment of the present invention may not overcome any of the problems described above.

According to an aspect of the invention, there is provided an apparatus for configuring an animated graphic image comprising: an effect handler analyzing an animated graphic image format including an image header having information on the number of components used for image configuration, component headers having information on the components used for image configuration, effect headers having information on effects applied to each component, and component images corresponding to each component and repetitively performing an operation of configuring an image frame and an operation enabling the image generated by the configuration of the image frame to be displayed; an image decoder decoding the component image included in the animated graphic image format; a storage unit storing header information generated by the analysis performed by the effect handler and a component image decoded by the image decoder; and an image output unit displaying the image generated by the effect handler.

According to an aspect of the present invention, the component header of the animated graphic image format may comprise information on repetition of the image configuration and delay time for repetition, and the effect handler may repetitively perform an operation of configuring an image frame and an operation enabling the generated image to be displayed according to the information on repetition of the image configuration and delay time for repetition.

In addition, two or more effects of a different type may be applied simultaneously, but effects of the same type may be applied only consecutively.

According to another aspect of the invention, there is provided a method of configuring an animated graphic image, the method comprising: receiving an animated graphic image format comprising an image header having information on the number of components used for image configuration, component headers having information on the components used for image configuration, effect headers having information on effects applied to each component, and component images corresponding to each component; analyzing the animated graphic image format and storing the header information included in the headers; decoding the component images and storing decoded images; configuring an image frame using the header information and the decoded component images; displaying the image generated in the configuration of the image frame; and repeating the configuration of the image frame and the displaying of the image.

According to another aspect of the invention, there is provided an effect handler comprising: a receiving unit receiving an animated graphic image format comprising an image header having information on the number of components used for image configuration, component headers having information on the components used for image configuration, effect headers having information on effects applied to each component, and component images corresponding to each component; and an image processing unit analyzing the animated graphic image format, configuring an image frame using header information obtained by the analysis and a decoded component image, and repetitively performing the operation of configuring an image frame and an operation enabling the image generated by the configuration of the image frame to be displayed.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram illustrating a structure of a conventional animated GIF file;

FIG. 2 is a schematic block diagram of an apparatus for animated graphic image configuration according to an exemplary embodiment of the present invention;

FIG. 3 is a schematic diagram illustrating an animated graphic image format used in the apparatus for animated graphic image configuration illustrated in FIG. 2 according to an exemplary embodiment of the present invention;

FIG. 4 is a schematic diagram illustrating a structure of a component header included in the animated graphic image format illustrated in FIG. 3 according to an exemplary embodiment of the present invention;

FIG. 5 is a schematic diagram illustrating a structure of an effect header included in the animated graphic image format illustrated in FIG. 3 according to an exemplary embodiment of the present invention;

FIG. 6 is a flow-chart illustrating a method of configuring animated graphic images according to an exemplary embodiment of the present invention; and

FIG. 7 is an exemplary diagram illustrating an animated image generated according to an exemplary embodiment of the present invention.

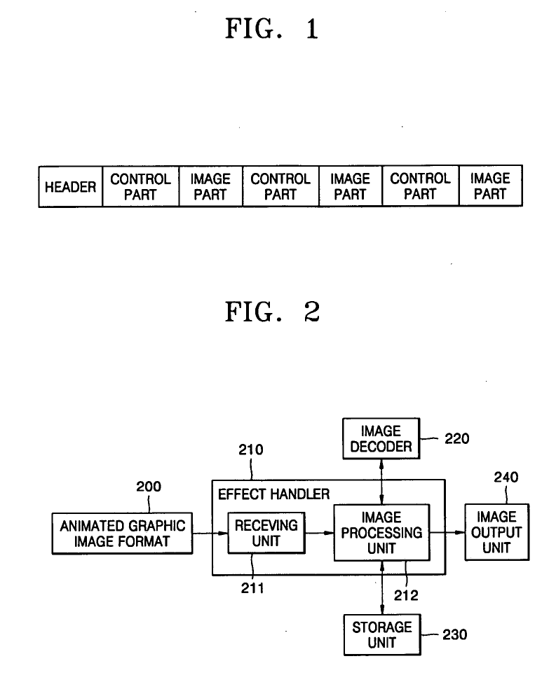

### DETAILED DESCRIPTION OF THE EXEMPLARY EMBODIMENTS

Hereinafter, the present invention will be described in detail by explaining exemplary embodiments of the invention with reference to the attached drawings. Like reference numerals denote like elements in the drawings.

FIG. 2 is a schematic block diagram of an apparatus for animated graphic image configuration according to an exemplary embodiment of the present invention.

Referring to FIG. 2, the apparatus for animated graphic image configuration includes an effect handler 210, an image decoder 220, a storage unit 230, and an image output unit 240.

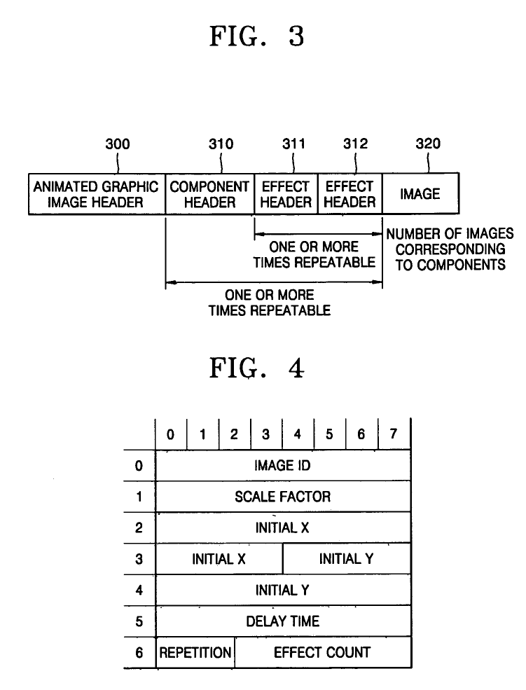

FIG. 3 is a schematic diagram illustrating an animated graphic image format 200 used in the apparatus for animated graphic image configuration illustrated in FIG. 2 according to an embodiment of the present invention. The effect handler 210, as illustrated in FIG. 2, analyzes the animated graphic image format 200 including an animated graphic image header 300, a component header 310, effect headers 311 and 312, and an encoded component image 320 and stores header information obtained from the analysis in the storage unit 230. The image decoder 220 decodes the encoded component image 320, and the decoded component image is stored in the storage unit 230. The effect handler 210 configures an image frame using the header information and the component image decoded by the image decoder 220 and displays the image generated by the configuration of the image frame through the image output unit 240. The effect handler 210 generates an animated graphic image by repetitively performing an operation of configuring an image frame and an operation enabling the image generated by the configuration of the image frame to be displayed according to information on repetition of the image configuration and delay time for repetition among component header information.

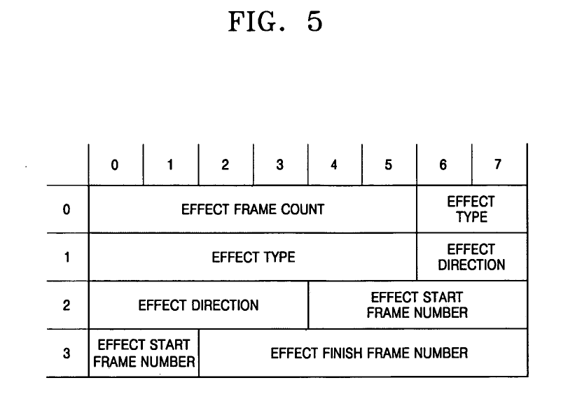

Structures of the component header 310 and the effect headers 311 and 312 composing the animated graphic image format 200 are shown respectively, in FIG. 4 and FIG. 5 according to exemplary embodiments of the present invention. The image header 300 composing the animated graphic image format 200 may include version information and image information including the number of components being used for image configuration. The component header 310 may include information on an image ID, the location and magnitude of a component image, repetition of image configuration, delay time for repetition, and an effect count. The effect headers 311 and 312 may include information on an effect frame count, an effect type, an effect direction, an effect start frame number, and an effect finish frame number. One or more component images 320 corresponding to the number of components are included in the animated graphic image format 200.

The animated graphic image format 200 may include one or more components, and one or more effects may be applied to each component simultaneously. However, effects of the same kind cannot be applied simultaneously. For example, effects can be classified into a background type, a transition effect type, a moving type, a scale type and the like. When a background type effect is applied to a component, an effect of a type other than the background type may be applied to the component simultaneously. However, a different effect of the same background type cannot be applied together simultaneously. But effects of the same type may be applied together, when the effects are applied consecutively. Here, it is determined according to the effect start frame number and the effect finish frame number included in the effect headers 311 and 312 illustrated in FIG. 5, whether an effect is applied simultaneously or consecutively.

The effect handler 210 includes a receiving unit 211 receiving the animated graphic image format 200 and an image processing unit 212 analyzing the animated graphic image format 200, configuring an image frame using header information included in the headers and a component image decoded by the image decoder 220, and repetitively performing the operation of image frame configuration and an operation enabling the image generated by the configuration of the image frame to be displayed through the image output unit 240 according to the information on repetition of the image configuration and delay time for repetition among the header information for displaying an animated graphic image.

In another exemplary embodiment of the present invention, it may be possible to implement the effect handler 210 and the image decoder 220 into one apparatus.

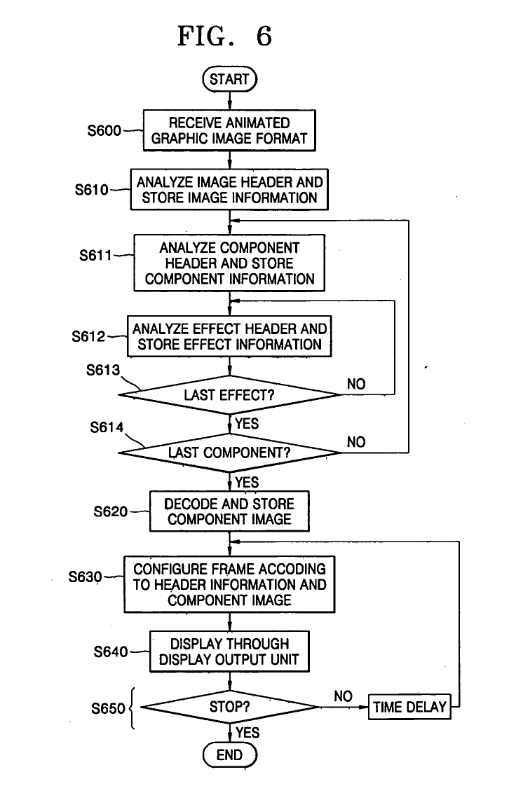

FIG. 6 is a flow-chart illustrating a method of configuring animated graphic images according to an exemplary embodiment of the present invention

The receiving unit 211 of the effect handler 210 receives the animated graphic image format 200 including the image header 300, the component header 310, the effect headers 311 and 312, and the component image 320 (S600). The image processing unit 212 of the effect handler 210 analyzes the headers of the animated graphic image format 200 and stores image information, component information, and effect information in the storage unit 230 (S610, S611, and S612). At this time, it is determined whether an effect undergoing the effect header analysis and storage operation S612 is the last effect or not (S613). When another effect exists, the next effect header is analyzed, and the effect information is stored, and when it is the last effect, it is determined whether the component undergoing the header analysis and storage operation S611 is the last component (S614). When another component exists, the component header and effect header analysis and storage operations S611, S612, and S613 are repeated.

The image decoder 220 decodes the component image, and the decoded component image is stored in the storage unit 230 (S620). The image processing unit 212 of the effect handler 210 determines the location and magnitude of each component according to the component information and determines the shape of a component to be displayed in a frame according to the effect information for configuring an image frame (S630). The new image generated in the configuration of the image frame is displayed through the image output unit 240 (S640). The image processing unit 212 of the effect handler 210 repeats the frame configuration operation S630 and the display operation S640 according to the information on repetition of the image configuration and delay time for repetition defined by each component header 310 (S650). The new images generated are displayed through the image output unit 240 continuously with a time delay defined by the component header 310, and each component is processed repetitively according to the number of times for repetition of the image configuration defined by the component header 310.

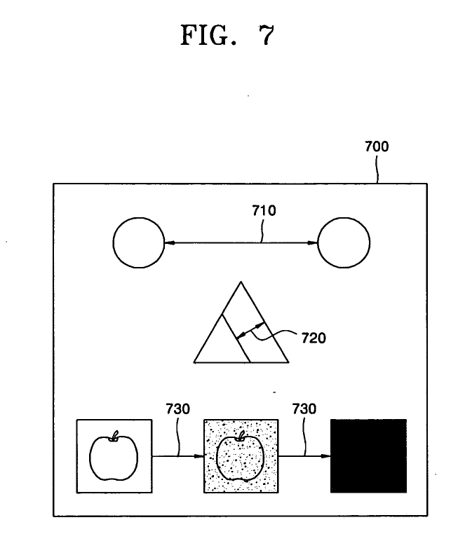

FIG. 7 is a diagram illustrating an animated image generated according to an exemplary embodiment of the present invention.

The image illustrated in FIG. 7 includes four components, and an effect is applied to each component. First, a square 700 forming background is the result of application of a background effect. An arrow 710 between circle images indicates a moving path of a circle image applied to a moving effect. An arrow 720 in a triangle image indicates a scale change of a triangle image applied to a scaling effect. Arrows 730 between square images in which a shape of an object is displayed indicates a time passage of a disappearance of the shape of the object applied to a scattering effect among transition effects. The square in which the shape of the object is displayed will be filled with scattering black dots, and the shape of the object will disappear. When the effects are to be implemented during 60 frames, while 60 images are required in a conventional animated GIF, according to the method of the present invention, only one component image is required for each component, and required effects are applied to the component images, respectively.

As described above, since there is no need to have all images corresponding to each frame in an apparatus or a method for animated graphic image configuration according to an exemplary embodiment of the present invention, different to that of a conventional animated GIF, only a small amount of resources is used, and since each component can be displayed independently, sufficient effects may be implemented as required.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for configuring an animated graphic image comprising:
an effect handler which analyzes an animated graphic image format and configures an image frame based on the analyzed animated graphic image format, wherein the animated graphic image format comprises:
an image header having information on a number of components used for image configuration;
a component header having information on components used for image configuration;
effect headers having information on effects applied to each component; and
component images corresponding to each component, and;
a storage unit which stores the image header information, the component header information and the effect headers information generated by the analysis performed by the effect handler and the component images.

2. The apparatus for configuring an animated graphic image according to claim 1, further comprising an image decoder which decodes the component images included in the animated graphic image format when the component images are encoded component images,
wherein the effect handler configures the image frame based on the stored information and enables the image frame to be displayed.

3. The apparatus for configuring an animated graphic image according to claim 1, further comprising:
an image output unit which displays the image frame configured by the effect handler.

4. The apparatus of claim 2, wherein the component header of the animated graphic image format comprises information on repetition of the image configuration and a delay time for repetition, and the effect handler repetitively performs the operations of configuring an image frame and enabling the generated image to be displayed according to the information on the repetition of the image configuration and the delay time for repetition.

5. The apparatus of claim 2 , wherein two or more effects of a different type are applied simultaneously and effects of the same type are applied consecutively.

6. The apparatus of claim 1, wherein the image header comprises at least one of version information and the number of components used for image configuration,
wherein the component header comprises at least one of image identification information, locations of the component images, magnitudes of the component images, repetition information, delay information and an effect count,
wherein the effect headers comprise at least one of an effect frame count, an effect type, an effect direction, an effect start frame and an effect finish frame.

7. A method of configuring an animated graphic image, the method comprising:
receiving an animated graphic image format comprising an image header having information on the number of components used for image configuration, component headers having information on the components used for image configuration, effect headers having information on effects applied to each component, and component images corresponding to each component;
analyzing the animated graphic image format and storing the header information included in the headers;
decoding the component images and storing decoded images; and
configuring an image frame using the header information and the decoded component images.

8. The method of configuring an animated graphic image according to claim 7, further comprising:
displaying the image frame generated by the configuration of the image frame; and
configuring a successive image frame to be displayed following the displaying of the image frame.

9. The method of configuring an animiated graphic image according to claim 8, wherein the image header comprises at least one of version information and the number of components used for image configuration,
wherein the component header comprises at least one of image identification information, locations of the component images, magnitudes of the component images, repetition information, delay information and an effect count,
wherein the effect headers comprise at least one of an effect frame count, an effect type, an effect direction, an effect start frame and an effect finish frame.

10. An effect handler comprising:
a receiving unit which receives an animated graphic image format comprising an image header having information on the number of components used for image configuration, component headers having information on the components used for image configuration, effect headers having information on effects applied to each component, and component images corresponding to each component; and
an image processing unit which analyzes the animated graphic image format to determine the image header, the component headers, the effect headers and the component images to configure an image frame.
